(19) United States
(12) Patent Application Publication
(10) Pub. No.: US 2015/0128560 A1
(43) Pub. Date: May 14, 2015

(54) MAGNETICALLY SHIELDED MINIATURE HALL THRUSTER

(71) Applicant: THE REGENTS OF THE UNIVERSITY OF CALIFORNIA, Oakland, CA (US)

(72) Inventors: Ryan W. Conversano, Pasadena, CA (US); Dan M. Goebel, Tarzana, CA (US); Richard E. Wirz, Los Angeles, CA (US)

(73) Assignee: THE REGENTS OF THE UNIVERSITY OF CALIFORNIA, Oakland, CA (US)

(21) Appl. No.: 14/506,635

(22) Filed: Oct. 4, 2014

Related U.S. Application Data
(60) Provisional application No. 61/887,220, filed on Oct. 4, 2013.

(51) Int. Cl. F03H 1/00

(52) U.S. Cl. CPC F03H 1/0068
USPC 60/202

(57) ABSTRACT

Magnetically shielded miniature Hall thrusters are disclosed that use a unique magnetic field topology that prevents the magnetic field lines from intersecting the discharge channel walls in the acceleration region of the thruster. Instead, the lines of force originating from both the inner and outer pole pieces curve around the downstream edges of the discharge channel and follow the channel walls towards the anode. This unique field topology results in low electron temperature at the discharge channel walls while eliminating strong electric field components that would otherwise lead to high erosion rates and power deposition from ion acceleration into the channel walls.

### CROSS-REFERENCE TO RELATED APPLICATIONS

This application claims priority to, and the benefit of, U.S. provisional patent application Ser. No. 61/887,220 filed on Oct. 4, 2013, incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

Not Applicable

### BACKGROUND

1. Technical Field

This disclosure pertains generally to Hall thrusters, and more particularly to miniature Hall thrusters.

2. Background Discussion

A long-life, low-power Hall thruster would be attractive for a wide range of NASA missions. Such a thruster would provide deep space and near Earth mission planners with the combined advantages of high specific impulse (>1500 s) and high thrust-to-power ratio (>50 mN/kW) at a reduced scale. Numerous miniature Hall thrusters have been developed in an effort to meet this need. However the primary challenges for Hall thrusters at small scales (e.g. <500 W and <7 cm in diameter) are poor life and low efficiency due to rapid erosion of and high electron-losses to the discharge channel walls as a result of the inherently higher surface-to-volume ratio of small thrusters. To combat low performance and efficiency caused by high surface-to-volume ratios, miniature Hall thrusters are often designed with wide discharge channels relative to the size of the thruster. This corresponds to an increased channel volume compared to the channel surface area, thereby reducing the surface-to-volume ratio at reduced scales.

Historically, high erosion rates have caused increased ion bombardment at a miniature Hall thruster's optimum discharge voltage. This has led to a reduction in operational discharge voltages to reduce erosion and extend thruster lifetimes. As a result, the efficiency of existing thrusters has significantly decreased below desirable levels.

### BRIEF SUMMARY

Magnetically shielded Hall thrusters benefit from a unique magnetic field topology that prevents the magnetic field lines from intersecting the discharge channel walls in the acceleration region. Instead, the lines of force originating from both the inner and outer pole pieces curve around the downstream edges of the discharge channel and follow the channel walls towards the anode. This unique field topology results in low electron temperature at the discharge channel walls while eliminating strong electric field components that would otherwise lead to high erosion rates from ion acceleration into the channel walls.

A magnetically shielded miniature (MaSMi) Hall thruster according to an embodiment of the technology described herein is a miniaturized Hall effect thruster that employs a unique magnetic field geometry called “magnetic shielding.” This field topography prevents the intersection of the grazing magnetic field line (the line coming closest to the discharge channel wall) with the discharge channel. Instead, the grazing field line penetrates into the anode region of the thruster, accessing cold electrons and holding them near the channel walls. A significant reduction in the wall sheath potential and a plasma potential nearly equal to the discharge voltage near the walls result from the unique field topography, yielding a significant reduction in the radial electric field component along the channel that would normally accelerate nearby ions into the channel walls. This virtually eliminates the effects of ion bombardment erosion of the thruster channel walls, which is the primary failure mechanism in conventional Hall thrusters. The use of magnetic shielding has demonstrated significantly longer thruster lifetimes when used in 4+ kW Hall thrusters.

A unique feature according to some embodiments of the current disclosure is the utilization of the magnetic shielding to improve the efficiency of small Hall thrusters. Magnetic shielding has demonstrated the potential for longer thruster life in standard size (>4 kW) Hall thrusters to date, but not improvements in efficiency. The increased plasma-wall interactions common to low-power Hall thrusters results in greater high-energy electron losses to the wall, yielding increased operating temperatures and poorer efficiency (typically <40%). By properly designing magnetic shielding geometries specifically for small Hall thrusters, we can greatly reduce the power deposition to the walls and enable small Hall thrusters to operate with unprecedented high total efficiencies (at least by 30% and possibly ≧50%).

The small size of the device allows for a variety of spacecraft applications. The MaSMi Hall thruster may be used as a primary method of propulsion for small-satellites (i.e. CubeSats and SmallSats) designed for long-duration missions. This thruster is also capable of delivering precise applications of low thrust, making it an ideal candidate for highly accurate pointing or orbit maintenance on larger spacecraft.

An embodiment of the technology described herein uses magnetic shielding to directly and dramatically improve the efficiency and life of miniature Hall thrusters by reducing erosion of the channel walls and providing lower operating temperatures, has significant implications due to the high surface area-to-volume ratio and smaller component dimensions of miniature Hall thrusters.

Historically, high erosion rates caused increased ion bombardment at a miniature Hall thruster's optimum discharge voltage. This has led to a reduction in operational discharge voltages to reduce erosion and extend thruster lifetimes. As a result, the efficiency of existing thrusters has significantly decreased below desirable levels. The MaSMi Hall thruster of the present disclosure overcomes high erosion rates experienced with existing art thrusters by virtually eliminating energetic ion bombardment of the channel walls at any discharge voltage. This allows the discharge voltage to be set to optimum levels for a given miniature thruster design, yielding the best total thruster efficiency possible.

Elevated operating temperatures also lead to reduced efficiency in Hall thrusters. High thruster temperatures are primarily due to power deposition of electrons to the channel walls. This occurs because the magnetic field lines in conventional Hall thrusters intersect the channel walls, allowing high-energy electrons confined to these field lines to impact the channel. To mitigate this problem, the MaSMi Hall thruster of the present disclosure is configured to have magnetic field lines do not intersect the channel walls, but rather follow the wall's surface and loop over the channel edges near the exit region. This magnetic field topography effectively pushes the thruster's ionization and acceleration regions of the thruster further downstream than is observed in conventional Hall thrusters, yielding lower operational temperatures due to decreased high energy plasma-wall interactions. These effects can result in dramatically reduced operating temperatures (12% to 16% proven in a 6 kW thruster), which can translate to significantly increased total thruster efficiency in low-power thruster applications.

Significant modifications to the magnetic field topography are achieved according to some embodiments of the technology described herein by changing this geometry. This is accomplished through the inclusion and/or modification and proper placement of magnetic screens between the inner and outer pole pieces and the plasma discharge channel. In some embodiments, these screens are thin, hollow, open-ended cylinders added to the Hall thruster's magnetic core that border the thruster's discharge channel. The magnetic field generated by the thruster's inner and outer magnetic coils is shunted by these screens, forcing the magnetic field lines connecting the two pole pieces into a “U” shape across the discharge channel opening. Proper placement and sizing of the screens results in magnetic field lines that travel from the front face of the pole pieces over the lip of the channel wall (grazing field lines) and then along the discharge channel wall towards the anode. At no point do these field lines intersect channel walls.

In embodiments that utilized a larger thruster size (on the order of 5 or 6 cm channel diameter) more generous spacing between the pole pieces and screens was allowed. For 4.4 cm channel diameter embodiments, it was found that the gap between the inner screen and inner pole piece

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 shows a radial, cross-sectional schematic view of a magnetically shielded miniature (MaSMi) (˜4 cm diameter) Hall thruster operating in the 300 W to 400 W range.

FIG. 2 shows a radial, cross-sectional schematic view of a MaSMi Hall thruster having an elbow in the inner screen component and shortened inner coil and outer coil.

FIG. 3 shows a radial, cross-sectional schematic view of a MaSMi Hall thruster having an elbow in the inner screen component and shortened inner coil.

FIG. 4 shows a radial, cross-sectional schematic view of a MaSMi Hall thruster having an elbow in the inner screen component and shortened inner coil and outer coil, and an inner coil that is thicker than the outer coil.

FIG. 5 shows a radial, cross-sectional schematic view of a MaSMi Hall thruster having an inner screen geometry that is spaced very close to the other thruster components for a compact design.

FIG. 6 shows a radial, cross-sectional schematic view of a MaSMi Hall thruster having a gap between the inner screen and the inner coil.

FIG. 7 shows a radial, cross-sectional schematic view of a MaSMi Hall thruster having gaps between both the inner screen and the inner coil and the outer screen and the outer coil, along with a lengthened discharge channel and larger inner and outer poles.

FIG. 8 shows a radial, cross-sectional schematic view of a MaSMi Hall thruster having a gap in the outer screen and the outer coil.

FIG. 9 shows a radial, cross-sectional schematic view of a MaSMi Hall thruster employing a Hiperco 50A material properties dataset.

FIG. 10 shows a radial, cross-sectional schematic view of a MaSMi Hall thruster employing dramatically different cross sections of the inner and outer screens.

FIG. 11 shows a radial, cross-sectional schematic view of a MaSMi Hall thruster having a double-chamfered discharge channel.

FIG. 12 is a plot of electron temperature and total power deposition as a function of discharge voltage calculated for an unshielded 44 mm Hall thruster operating at 1.3 A discharge current.

FIG. 13 is a simulation of the MaSMi thruster external magnetic field structure, confirming that no separatrix is present

FIG. 14A and FIG. 14B are images illustrating operation of the MaSMi thruster at 275 V and 325 W with FIG. 14B showing a magnified view of the upper region of the discharge channel showing a slight offset of the plasma from the wall indicative of magnetic shielding.

FIG. 15A and FIG. 15B are images comparing the MaSMi thruster discharge channel before (FIG. 15A) and after (FIG. 15B) testing. The layer of carbon back-sputter suggests the presence of magnetic shielding.

FIG. 16A shows a plot of current density as a function of the planar probe's lateral position from the thruster centerline, uncorrected for background charge exchange ion effects and measured for nominal MaSMi thruster operating conditions at 4.4 cm and 10.8 cm downstream of the thruster face.

FIG. 16B shows a plot of current density as a function of the planar probe's lateral position from the thruster centerline, corrected for background charge exchange ion effects and measured for nominal MaSMi thruster operating conditions at 4.4 cm downstream of the thruster face.

FIG. 17 shows a plot of RPA scans of normalized ion current and its normalized derivative as functions of the ion discriminator grid potential for the MaSMi thruster nominal operating condition.

### DETAILED DESCRIPTION

The primary life-limiting factor of conventional Hall thrusters is erosion of the discharge channel walls from ion bombardment. Due to the zero net current condition at the insulating walls, a large sheath potential forms to reject the bulk of the electron population. In turn, the electron repelling sheath adds to the radial electric field component from the bulk plasma that accelerate nearby ions into the walls. The resultant sputter erosion of the wall is concentrated near the exit plane and can wear through the discharge channel walls, exposing the thruster's pole pieces to ion bombardment. Degradation of the pole pieces alters the interior magnetic circuit of the device, eventually degrading the performance of the thruster and ending its useful life.

Another key performance-limiting factor in Hall thrusters is high-energy electron power loss to the discharge channel walls. In conventional Hall thrusters, the radial magnetic field lines near the exit plane intersect the channel walls. High-energy electrons flow along these field lines, and the most energetic ones bombard the discharge channel walls while the bulk of the distribution is reflected back into the plasma by either the plasma sheath or the magnetic mirror created at the pole pieces. This electron power deposition results in performance-robbing heating of the Hall thruster that can also affect operational lifetime due to temperature limitations of the thruster's materials and construction.

Ion bombardment and electron power loss effects increase rapidly in low-power Hall thrusters primarily due to their characteristically larger surface-to-volume ratios. The erosion rates of conventionally sized and miniature Hall thrusters are comparable; however, shorter operational lifetimes are observed in miniature devices due to their reduced channel wall thickness. Operational lifetimes of miniature Hall thrusters are generally low, ranging from tens of minutes to hundreds of hours with few devices surviving beyond 1,000 hours.

1. Magnetically Shielded Miniature Hall Thruster Configuration

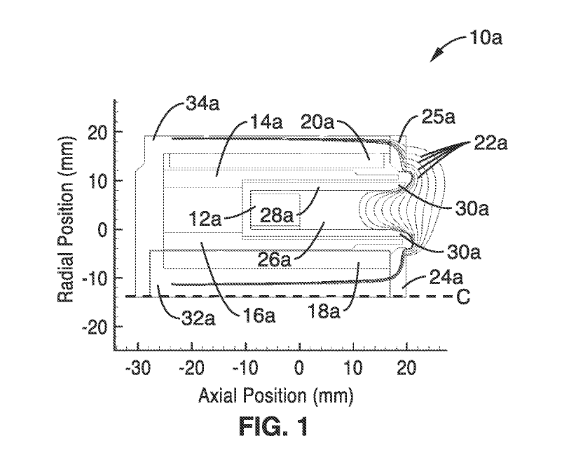

Thrusters 10a through 10k shown in FIG. 1 through FIG. 11 illustrate varying embodiments of a magnetically shielded miniature (MaSMi) (˜4 cm diameter) Hall thruster operating in the 300 W to 400 W range that demonstrates significantly increased operational lifetimes and improved performance compared to existing low-power Hall thrusters.

Referring to the radial cross-sectional view of FIG. 1, the magnetically shielded Hall thruster 10a of the present disclosure comprises a unique magnetic field topology that prevents the magnetic field lines 22a from intersecting the discharge channel walls 28a in the acceleration region of the discharge channel/component 26a of the thruster. Instead, the lines of force 22a originating from both the inner pole piece 24a and outer pole piece 25a curve around the downstream edges of the discharge channel 28a and follow the channel walls towards the anode 12a. A cathode (not shown) is also arranged proximate the exhaust port (at ends 30s) of the discharge channel 26a.

With respect to the magnetically shielded field topology, the isothermality of magnetic lines of force 22a assumes that the electron temperature (Tₑ) along a field line is essentially constant, or Tₑ≈Tₑ₀ where Tₑ₀ is the reference, or channel centerline, electron temperature. This property allows the deep-penetrating magnetic field lines to capture cold (˜5 eV) electrons near the anode 12a and transport these electrons adjacent to the discharge channel walls 28a, maintaining a low average electron temperature near the wall. Because the sheath potential is a function of electron temperature for a given material, the low electron temperature yields lower sheath potentials at the discharge channel walls 28a.

Another byproduct of the cold field lines is that the assumption of magnetic-force-line equipotentialization will hold to a greater extent near the walls than in conventional Hall thrusters. This is seen through the thermalized potential equation,

$$Φ \approx {Φ}_{0} + {T}_{e 0} \times ln ( \frac{{n}_{e}}{{n}_{e 0}} ) \qquad Eq . 1$$

where φ is the plasma potential, nₑ is the electron density, and the subscript 0 denotes the channel centerline (reference) values. The magnetically shielded Hall thruster 10a therefore maintains a plasma potential close to that of the discharge voltage along the length of the discharge channel 26a. Additionally, proper channel geometry and magnetic field design forces the electric field 22a to point nearly perpendicular to the discharge channel surfaces 28a.

For the magnetically shielded Hall thruster 10a, magnetic field line isothermality and magnetic-force-line equipotentialization significantly reduce the kinetic energy gained by ions passing through the potential drop along the channel walls 28a, thereby decreasing sputter erosion of the channel. The result is an increase of thruster lifetimes by as much as a factor of 1,000 compared to unshielded Hall thrusters. Additionally, because the field lines 22a do not intersect with the thruster walls 28a, high-energy electron confinement is improved while power deposition to the walls is reduced.

FIG. 1 shows a radial cross-sectional view, thus the discharge channel 26a is annular, and disposed between inner coil 18a and outer coil 20a. Centerline C represents the pictorial axis of rotation, and is concentric with the inner core 32a center. Outer housing 34a defines the outer extent of the thruster 10a.

In the embodiment shown in FIG. 1, the inner screen portion 16a (left-hand side) and the outer screen portion 14a (right-hand side) can be different thicknesses. In some embodiments, it may be desirable to make the inner screen portion as thick as the space allows.

The outer diameter of this Hall thruster 10a is generally less than 10 cm, although other sizes and thruster power levels are possible. In one embodiment discharge channel 26a employs a 2-to-1 length to width ratio, although other channel geometries are acceptable.

In one embodiment, the MaSMi Hall thruster 10a employs an outer channel diameter of 44 mm and a mean channel diameter of 36 mm. The discharge channel 26a has an 8 mm channel width and chamfered downstream edges 30a to avoid intersection with magnetic field lines. The thruster may use a single-chamfer design (as has been used in higher-power Hall thrusters) or a double-chamfer design in order to follow the shape of the optimized magnetic field topology. In this embodiment, the thruster 10a has a channel width-to-mean-diameter ratio of 0.222, placing it in line with the trends of conventional miniature Hall thrusters. The mean free path for ionization collisions is between 2 mm and 6 mm based on The MaSMi thruster expected performance range. A maximum discharge channel 26a length of 16 mm (providing a maximum discharge channel length-to-width ratio of 2) was selected to allow for variable anode 12a placement within the channel to optimize propellant mixing and ionization. During initial testing, the full 16 mm discharge channel 26a length was utilized.

In a preferred embodiment, anode 12a employs a two-chamber design for uniform propellant distribution: a first chamber (not shown) is intended to choke the propellant flow while a second chamber (separated from the first chamber via a dividing plate, both not shown) has an annular diffuser ring to encourage an even propellant flow distribution into the channel 26a.

With respect to material selection, iron is conventionally used for Hall thruster cores due to its favorable magnetic properties (good resistance to magnetic saturation) and its low cost and availability. On most scales (˜7+ cm), iron is not brought near its saturation point during normal thruster operation, and therefore is well suited for Hall thruster cores. However, for miniature scales as in the thruster 10a of the present disclosure, the amount of magnetic flux required through very small thruster components can quickly over-saturate iron. In a preferred embodiment, Hiperco (specifically, Hiperco 50A, an iron-cobalt-vanadium alloy) may be employed, which has a magnetic saturation point of over 50% higher than iron, can be used for the magnetic core 32a of the miniature hall thruster 10a. However, it is appreciated that other materials could potentially be used for the core material that would satisfy our magnetic flux requirements.

A single inner coil 18a and a single outer coil 20a, wrapped from AWG-22 nickel-plated and fiberglass-insulated high temperature copper magnet wire (rated to over 400° C.), provide the necessary fields to operate the thruster. In one embodiment, the discharge channel 26a is machined from HP-grade boron nitride (BN), although other materials are contemplated.

Since the dividing plate (between the two chambers) and the downstream diffuser rings face the discharge plasma during operation and are therefore machined from graphite to provide high emissivity and lower operational temperatures. The remaining parts of the anode 12a are machined from stainless steel.

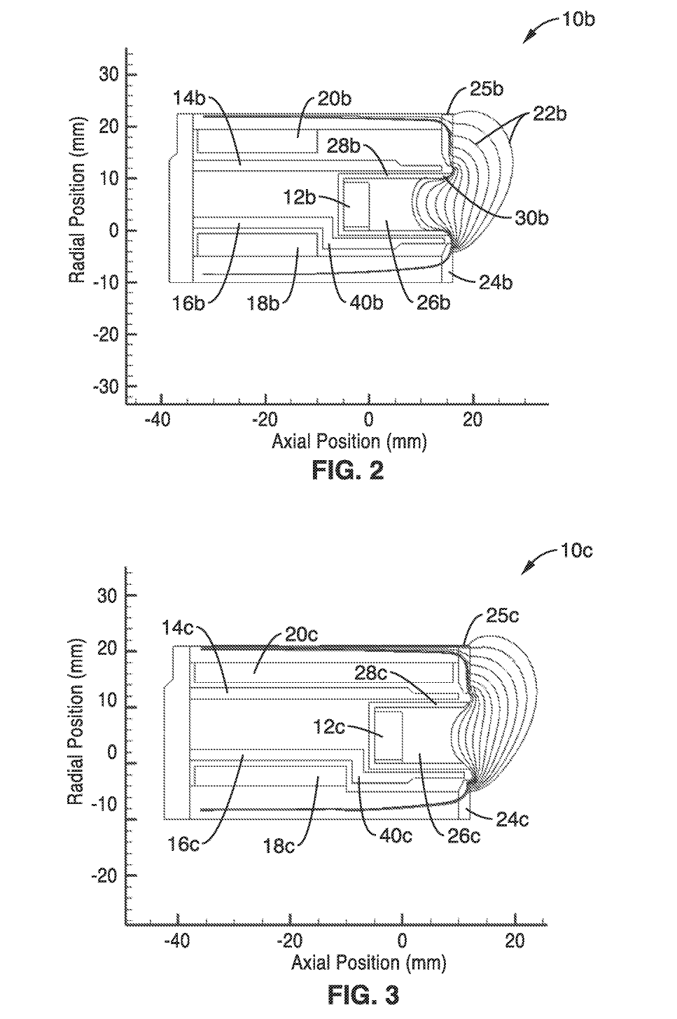

FIG. 2 through FIG. 11 show radial cross-sectional views of additional embodiments of MaSMi Hall thrusters 10b through 10k employing different geometric configurations. It is appreciated that the general concepts of the present disclosure are for illustrative purposed only, and embodiments utilizing the features of the present disclosure are not limited to the particular embodiments disclosed herein. It is appreciated that, where appropriate and unless otherwise specified, the dimensions and materials selection detailed above for the thruster 10a may also applied to MaSMi Hall thrusters 10b through 10k. It will also be appreciated that, unless otherwise specified or unless otherwise inherent or implied from the context, like reference numbers denote like parts (e.g., 12a through 12k, 14a through 14k, 16a through 16k, etc.).

The geometries of the MaSMi Hall thrusters 10b through 10j result in different magnetic fields as a function of varying discharge channel and other component shapes. Size limitations were found to be an important factor, leading to very unique inner-screen 16 geometries in some embodiments. Also, because of the sizing constraints, very unique and non-optimized pole piece 24/25 designs were implemented in some embodiments. It should be noted that in all examples, a magnetically shielded topography was achieved.

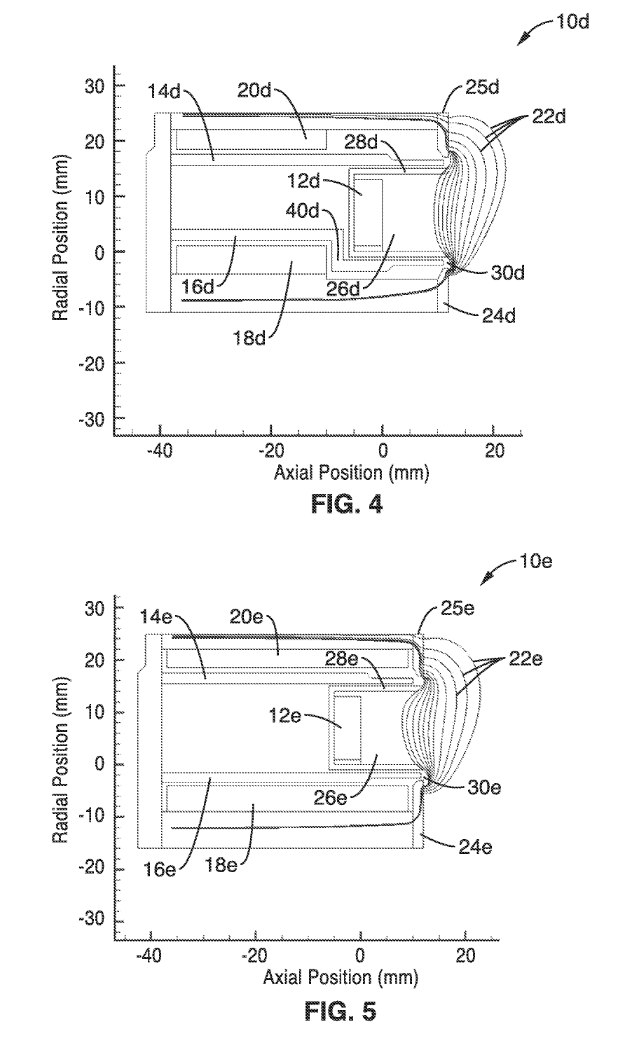

Referring to FIG. 2 through FIG. 4, MaSMi Hall thrusters 10b through 10d include an elbow (40b, 40c, 40d, respectively) in the inner screen (16b, 16c, 16d, respectively). The discharge channel 26b, 26c, and 26d length is shortened in each of the thrusters 10b through 10d, as compared to the discharge channel length of 26a of FIG. 1. Both the inner coil 18b and outer coil 20b are shortened in length in FIG. 2 and FIG. 4 respectively, while only the inner coil 18c is shortened in length in FIG. 3. As shown in FIG. 4, the inner coil 18d is thicker than the outer coil 20d.

In some embodiments (e.g., thruster 10e of FIG. 5), the inner screen 16e geometry is spaced very close to the other thruster components for a compact design. Inner and outer coils 18e, 20e, also have a length that extends substantially the length of the thruster, while the discharge channel 26e length is being shortened as in FIG. 4.

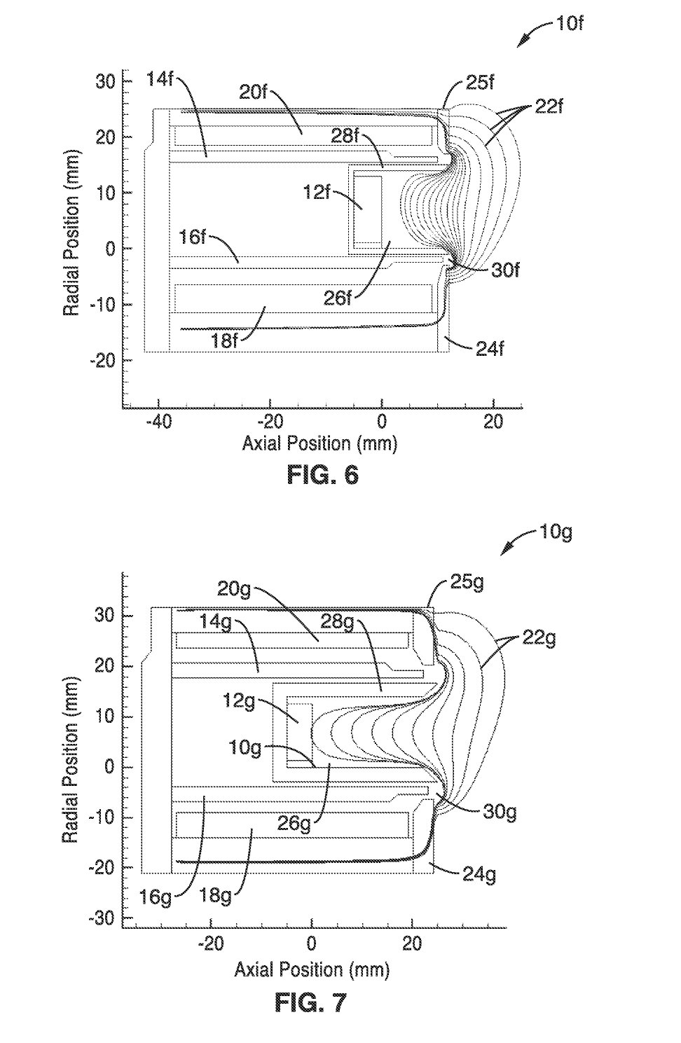

FIG. 6 illustrates an embodiment of a thruster 10f configuration similar to that shown in FIG. 5, except with a gap between the inner screen 16f and the inner coil 18f.

FIG. 7 illustrates a thruster 10g embodiment with gaps between both the inner screen 16g and the inner coil 18g and the outer screen 14g and the outer coil 20g, along with a lengthened discharge channel 26g and larger inner and outer poles 24g, 25g.

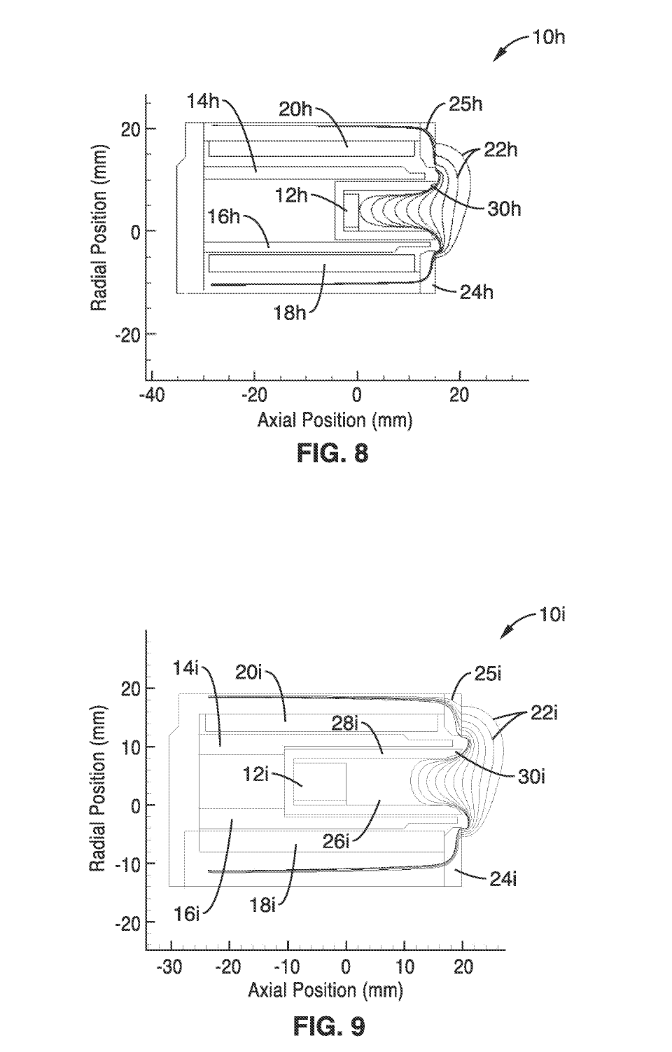

FIG. 8 illustrates a thruster 10h embodiment with a gap between the outer screen 14h and the outer coil 20h.

FIG. 9 illustrates a thruster 10i employing a Hiperco 50A material properties dataset. Note that the inner and outer screens 16i, 14i are slightly different (the inner screen 16i thin section extends further downstream near the inner pole piece 24i than the outer screen 14i to the outer pole piece 25i).

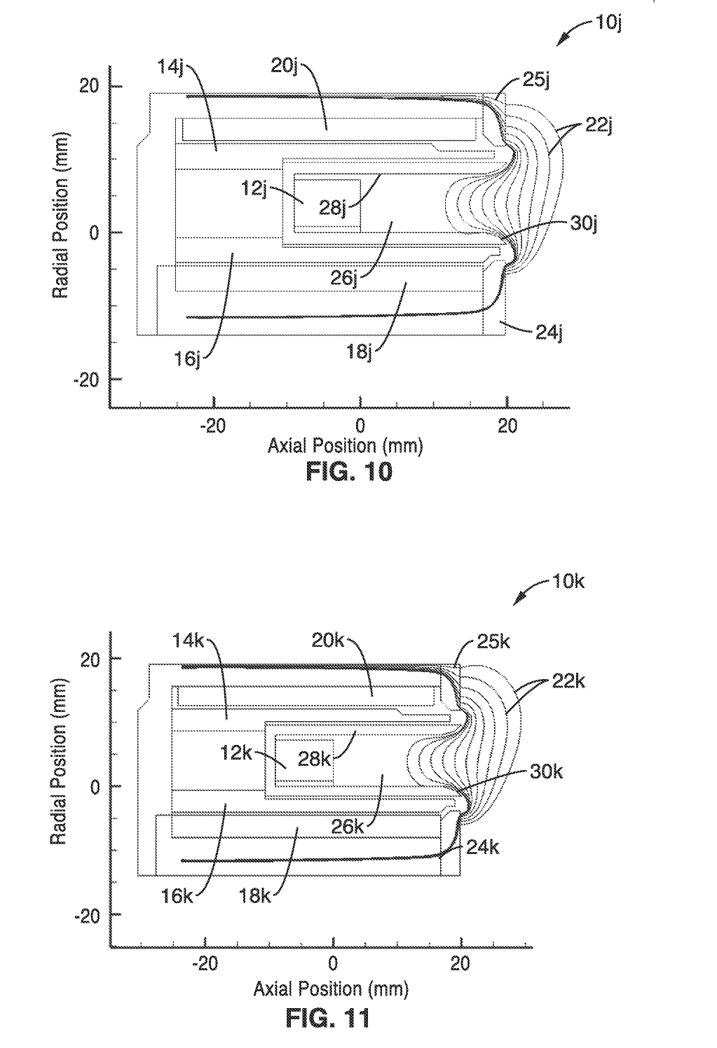

FIG. 10 illustrates a thruster 10j employing dramatically different cross sections of the inner and outer screens 16j, 14j. The inner screen 16j thin section is shorter near the inner pole piece 24i than the outer screen 14i to the outer pole piece 25i. This allows for as much material as possible into the inner screen 16i to avoid saturation conditions. It is noted in the last embodiment of thruster 10j that the field topography 22j is slightly asymmetrical. A slight modification in the current inputs to the two magnetic coils 18j, 20j would make the field topography more symmetric.

It should be noted that according to some embodiments of the present disclosure, the spacing of the screens axially with respect to the pole pieces is very close, e.g. ideally a total gap of 2 mm or less. This achieves a field topography that prevents the field lines from intersecting the discharge channel walls.

In embodiments that utilized a larger thruster size (on the order of 5 or 6 cm channel diameter) more generous spacing between the pole pieces and screens was allowed. For 4.4 cm channel diameter embodiments, it was found that the gap between the inner screen and inner pole piece can be extremely important to achieving a desirable field topography; the outer screen/pole piece gap was slightly more forgiving due to its larger distance from the high field region along the centerline of the thruster, but it can still be a critical design feature. Embodiments scaled down even further (e.g. 3 to 4 cm channel diameter) were tested with a similar geometry and found that other materials may be better suited to obtain a proper topography.

It was found that increasing or decreasing the axial and radial gap spacing by more than approximately 25% to approximately 50% beyond our optimum configuration, depending on the design, resulted in a non-desirable field topography (sometimes impossible to achieve a magnetically shielded topography with any coil current inputs) or one that required unreasonable coil currents that would stress conventional copper wires well beyond normal operation ranges.

Consequently, anywhere more than 100% change in the axial and radial gaps between the pole pieces and screens would generally result in a non-functioning magnetic shielding design.

A key to an effective MS thruster design is ensuring that the magnetic field lines do not intersect the discharge channel. Preferred embodiments of the present disclosure essentially eliminate ions from impacting the walls with enough energy to erode the surface (i.e. ion bombardment erosion) and prevent electron power deposition to the walls (i.e. excessive heating). A conventional thruster field topography utilizes field lines that intersect the discharge channel, resulting in very short operational lives for miniature thrusters.

Referring now to the shielded field topography of thruster 10k shown in FIG. 11, it is apparent that the shape of the penetrating field lines 22k are more square-shaped; that is, it follows the rectangular shape of the channel 26k. Additionally, the curvature near the two screens 14k, 16k and around the discharge channel downstream edge 30k is more dramatic (as stated above, a slight modification in the current inputs to the two magnetic coils would make the field topography more symmetric). It was found that, as the scale of the thruster is reduced, we get a “square” shape of the magnetic field topography that very closely follows the shape of the discharge channel 26k.

In order to accommodate the field structure 22k of FIG. 11, the discharge channel 26k may be “double-chamfered”; i.e., chamfered at two different angles at different downstream locations near opening 30k. This allows the channel 26k wall to closely follow the expected magnetic field lines 22k near the wall's surface 28k, while preventing any intersection of the two. Ideally, the wall 28k is configured to be as far downstream as possible to prevent line-of-sight from the plasma to the pole pieces 24k, 25k, while also being back from the magnetic field lines 22k enough to avoid any intersection of the two.

Some further embodiments can include one or more of the following:

(1) Using permanent magnets to reduce saturation issues characteristic with small thrusters. This would replace existing portions of the thruster core 32a currently made from iron or Hiperco 50A with strong permanent magnets. This may include fabricating the inner core 32a of the thruster with a permanent magnet wrapped in a magnetic coil. This would allow some degree of control over the exact strength of the resulting field (via the coil), but would also prevent saturation of a material as the core would itself be a magnet. The inner pole piece 24a would then be mounted on the downstream face of the inner core 32a.

(2) Instead of using the more simple single outer coil 20a (i.e. two concentric coils to operate the entire thruster), a multi-outer coil design (not shown) may be implemented; e.g., as used in thrusters such as the BPT-4000.

(3) Scaling up or down an MS thruster may inure that the screens be modified considerably to achieve the proper field topography.

(4) Using slight geometry changes, including increasing or decreasing the discharge channel diameter, to enable different power levels to be achieved.

(5) To ensure that the optimal magnetic field topology is achieved, portions or all of the magnetic circuit of the device may be fabricated from rare or exotic magnetic materials with favorable properties.

(6) Rather than the Hall thruster using a single inner and single outer coaxial magnet coil as described above, a magnetically shielded field topology may be achieved by the use of a single inner and multiple outer magnet coil design.

An analysis of the MaSMi Hall thruster's dimensions and predicted performance is presented in Section 2 below, followed by a discussion of the experimental investigation in Section 3.

2. Performance Modeling

A. Power Balance

The total power deposition to the discharge channel walls and anode can be estimated based on the thruster's operational parameters. It should be noted that the equations used for this power deposition model apply only to unshielded Hall thrusters; therefore, the power deposition experienced by MaSMi is expected to be significantly less than the model predicts. A linear curve fit of the secondary electron yield of boron nitride is used to predict finite secondary electron yields at low incident energies. The electron temperature at the thruster exit plane is then calculated using an iterative process outlined in the literature based on the linear secondary electron yields and the thruster operating parameters. The power input to the thruster to generate the beam (i.e. the discharge power, P_{d}), which by definition is equal to the total power out of the thruster, is modeled to the first order as:

P_{d}=P_{b}+P_{w}+Pₐ+P_{R}+Pᵢ Eq. 2

where P_{b} is the beam power, P_{w} is the power deposited to the discharge channel walls by electrons and ions, Pₐ is the power deposited to the anode by electrons, P_{R} is the plasma's radiative power loss, and Pᵢ is the power to produce ions that either become the beam or bombard the channel walls.

These power terms are presented as:

$$\begin{matrix}{P}_{b} = {V}_{b} {I}_{b} & Eq . 3 \\ {EP}_{w} = {n}_{e} {eA}_{w} [ {( \frac{{kT}_{e}}{e} )}^{3 / 2} {( \frac{2 e}{π m} )}^{1 / 2} {e}^{\frac{e {Φ}_{s}}{{kT}_{e}}} + \frac{1}{2} \sqrt{\frac{{kT}_{e}}{M}} ( ɛ - {Φ}_{s} ) ] & Eq . 4 \\ {P}_{a} = 2 {T}_{e V} {I}_{a} \approx 2 {T}_{e V} {I}_{d} & Eq . 5 \\ {P}_{R} = {n}_{o} {n}_{e} 〈 {σ}_{*} {v}_{e} 〉 {V}_{p} & Eq . 6 \\ {P}_{i} = ( {I}_{b} + {I}_{iw} ) {U}^{+} = [ {η}_{b} + {I}_{ew} ( 1 - γ ) ] {I}_{d} {U}^{+} & Eq . 7\end{matrix}$$

where V_{b} is the beam voltage, I_{b} is the beam current, e is the charge of an electron, A_{w} is the surface area of the inner and outer discharge channel walls in contact with the plasma, k is the Boltzmann constant, m is the mass of an electron, φₛ is the sheath potential relative to the plasma, M is the mass of a xenon atom, ε is the pre-sheath ion energy, T_{eV} is the electron temperature in electron volts, Iₐ is the current to the anode, I_{d} is the discharge current, nₒ is the neutral density, <σ*vₑ> is the excitation reaction rate coefficient including the excitation cross section and the electron velocity, Vₚ is the volume of the high-temperature plasma region, I_{iw} is the ion current to the walls, U⁺ is the ionization potential, η_{b} is the beam current utilization efficiency, I_{ew} is the electron current to the walls, and γ is the secondary electron yield.

To complete this analysis, several assumptions were made. The anode-region electron temperature was assumed to be 4 eV and the axial depth of the high-density plasma near the exit-region of the thruster was assumed to be 3 mm. The current and voltage efficiencies were assumed to be 70% and 90%, respectively, and the magnetic field strength at the peak field point was conservatively assumed to be 160 G. A discharge current of 1.3 A and a total propellant flow rate of 20 sccm were also assumed. Using these assumptions and the known MaSMi thruster dimensions, the various power loss terms presented in Equations 3 through 7, in addition to the beam power and the electron temperature, were calculated as functions of the discharge voltage.

The beam power, the net power carried by the plasma beam, is approximately 245 W according to the unshielded power model (Equations 2 through 7). The power deposited to the channel walls is broken into two terms: the first is the power deposition of electrons that overcome the repelling sheath potential and the second is the power deposition of ions that fall through the pre-sheath and sheath potentials (the cooling effect of emitted secondary electrons is neglected).

Electron and ion heating of the walls account for approximately 115 W and 4 W, respectively, of the total 145 W of power dissipated to the discharge channel walls in an unshielded MaSMi thruster. The remaining 25 W are contributions from xenon ionization, electron power deposition to the anode, and radiation. The xenon ionization power is 12.6 W and is not sensitive to changes in the thruster model's operation conditions.

The power deposited to the anode is calculated based on the assumption that the discharge current is effectively equal to the electron current collected at the anode and assumes that the plasma potential is equal or slightly higher than the anode potential. Electrons are assumed to deposit 2T_{eV} of energy from the plasma to the anode, totaling in approximately 10.5 W of power loss for the unshielded model.

The radiative power loss is the thermal power radiated by the plasma volume (the product of the discharge channel cross-sectional area and the axial thickness of the high-temperature plasma region) based on the excitation of neutrals in the plasma. Radiative power losses for the unshielded thruster total approximately 2.5 W. The power to produce ions is the sum of the power used to generate the beam ions (product of the beam current and the ionization potential) and the power used to create ions that will bombard the discharge channel walls (product of the ion current to the walls and the ionization potential). Alternatively, this power can be calculated based on the beam efficiency and the electron current to the discharge channel walls, accounting for emitted secondary electrons; the sum of these factors is multiplied by the discharge current and ionization potential. Ionization power to the beam and wall ions totals to approximately 17 W for the unshielded thruster model. Other terms, including the power electrons may carry into the beam, are generally small and can be neglected.

For the MaSMi thruster's original expected operating conditions (300 V, 1.3 A), the electron temperature is calculated to be approximately 18.3 eV with a total power deposition of approximately 145 W according to the power model (calculated for conventional unshielded Hall thrusters).

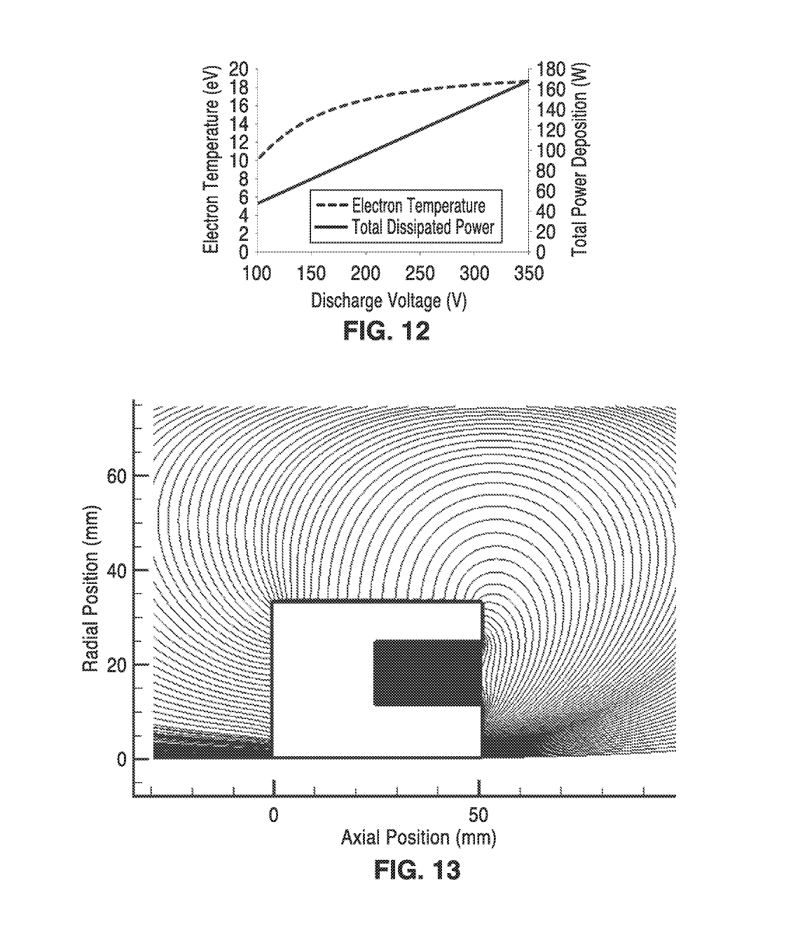

FIG. 12 shows the electron temperature and total power deposition to the discharge channel walls and anode for a variety of discharge voltages at the expected operation discharge current of 1.3 A. An additional 35 W of power is expected to be generated by the two magnetic coils during nominal operation based on a temperature-sensitive model relating applied current and resulting magnetic field strength. The 180 W of thermal power predicted by this model represents an important challenge that must be considered carefully for thruster and mission design efforts.

In terms of performance, the implementation of magnetic shielding on the H6 Hall thruster resulted in a slight drop in efficiency (1.7%), a significant drop in insulator ring (discharge channel downstream edge) temperature (12% to 16%), and an increase in specific impulse (2.9%) primarily due to an increase in multiply charged ions from the decreased electron wall losses and resulting higher electron temperature.

A model of the thruster's magnetic circuit predicts a magnetically shielded field topology with no intersection of the magnetic field lines and the discharge channel walls. Additionally, the predicted maximum magnetic field strength exceeded the required value to constrain electron Larmor radii to 10% of the discharge channel width (assuming an electron temperature of 20 eV) as is generally deemed optimal.

B. Thermal Model

A thermal balance was performed to determine the MaSMi thruster's temperature during operation based on the power deposition model presented above. This balance, only accounting for thermal radiation, is represented by

Qᵢₙₜ=σε_{R}A_{R}F(T_{M}⁴−Tₛ⁴) Eq. 8

where Qᵢₙₜ is the power lost from plasma-heating of the thruster, σ is the Stephan-Boltzmann constant, ε_{R} is the surface emissivity, A_{R} is the radiation surface area, F is the free-space-facing view factor (assumed to be 1 in our case), T_{M} is the MaSMi thruster's mean surface temperature, and Tₛ is the temperature inside the vacuum chamber (assumed to be room temperature). Assuming no conduction, a total plasma heating power loss of 180 W, an emissivity of 0.3 (bare Hiperco), and a radiation area equal to the surface area of the thruster body, the predicted operation temperature is 450° C., which exceeds the thermal rating of the insulated magnet wire (˜400° C.). In order to efficiently dissipate the predicted 180 W, a thermal radiator is fitted over the thruster's outer core. The radiator was constructed from four 1.59 mm thick copper sheets with a quarter-circular bend in the center and bolted together tightly in the shape of an “X” to ensure thermal contact with the thruster body. The two upper fins are spread apart for greater surface area. The radiator, with a total space-viewing surface area of approximately 1000 cm², is oxidized (emissivity ˜0.75) to yield a predicted thruster operation temperature of approximately 195° C.

Conventional Hall thrusters generally have one of two magnetic coil configurations to achieve the desired field topology. The first configuration uses discrete outer coils located at multiple, equally spaced azimuthal locations oriented parallel to the thruster's axis. These coils are magnetically coupled to the thruster's magnetic core to complete the thruster's magnetic circuit. The second thruster configuration uses a single outer coil, concentric with the thruster's discharge channel and oriented along the thruster's axis. This single coil is generally sheathed by the thruster's outer core to connect the coil to the thruster's magnetic circuit. In either design, a single inner magnet coil located radially inward from the inner wall of the discharge channel may be implemented.

Thrusters using discrete outer coils generate two species of field lines that extend outside of the thruster body. The first circulates through the magnetic circuit and then travels from the inner pole to the outer pole. The second extends from the front of the outer coils and then reconnects at the back of the coils, traveling around the thruster body (not conducted by the magnetic circuit). Thrusters using a single outer coil generate only one magnetic field line species that extends outside the thruster body. These field lines travel from the thruster's inner pole and reconnect at the outer pole, sides, and rear of the thruster body to be circulated through the thruster's magnetic circuit.

The placement of the thruster's hollow cathode is a critical design feature depending on a thruster's magnetic coil configuration. Work is necessary for electrons born from the cathode to travel to the anode and ion beam, overcoming both strong magnetic fields and insufficient collision frequency, to maintain charge quasi-neutrality. The minimization of this work, which can be considered an energy loss mechanism, results in more effective cathode coupling with the thruster and improved thruster efficiency. In the case of a Hall thruster with discrete outer coils, the magnetic field is divided into two regions of similarly connected flux lines (the two different species of flux lines discussed above); the boundary between these regions is called the separatrix.

In an effort to examine cathode coupling, the MaSMi thruster's far-field magnetic field structure was simulated to determine the location of the separatrix. The fields model suggests that that no separatrix exists in the MaSMi thruster's external magnetic field structure, as shown in FIG. 13. Based on this observation, cathode placement should not be a major concern for strong cathode coupling and efficient operation of the MaSMi Hall thruster.

3. Experimental Results

Experiments were carried out in the Electric Propulsion Test Facility in the Plasma and Space Propulsion Laboratory at UCLA. The UCLA Electric Propulsion Test Facility uses a custom built cylindrical chamber measuring 2.8 m long with a diameter of 1.8 m. Two CTI CryoTorr-10 cryogenic pumps operate in parallel for a combined xenon pumping speed of about 1300 l/s. This system is capable of achieving a base pressure of approximately 5×10⁻⁷ Torr, and during nominal operation with an approximate xenon flow of 12 sccm, the chamber pressure remained in the mid 10⁻⁵ Torr range (corrected for xenon).

The five power supplies used for normal operation of the MaSMi Hall thruster and supporting hollow cathode were installed on a power supply rack adjacent to the Electric Propulsion Test Facility vacuum chamber. The MaSMi thruster's anode potential was provided by a Sorensen DLM 300-2 power supply while the inner and outer magnet coils were powered by a pair of Sorensen DLM 20-30 power supplies. Sorensen DLM 40-15 and DLM 150-4 power supplies were used for the hollow cathode's heater and keeper, respectively. Research grade xenon was supplied to the thruster by an Apex AX-DM 50 sccm mass flow controller and to the cathode by an Apex AX-DM 5 sccm mass flow controller.

The MaSMi was coupled to a BaO-W cathode based on the ISS plasma contactor cathode and the NSTAR ion thruster cathode. The cathode has a 0.75 mm diameter cathode orifice and a tantalum keeper with a 3 mm diameter orifice. All other dimensions are similar to the NSTAR hollow cathode. During initial testing, the cathode was mounted parallel to the thruster axis with the cathode orifice approximately 6.6 cm (1.5 channel outer diameters) above the thruster centerline. In an effort to enhance cathode coupling, the MaSMi thruster's cathode was mounted at a 22.5° angle relative to the thruster's centerline axis with the orifice approximately 10 mm above the thruster body in the plane of the thruster face and directed towards the beam. This configuration yielded superior stability during thruster operation and was maintained throughout all ensuing performance characterization testing.

A high energy beam dump, consisting of a 1.25 m×1.25 m square of 1.59 mm carbon felt mounted to a grounded aluminum frame, was mounted 80 cm downstream of the MaSMi Hall thruster. The close proximity of the beam dump to the thruster was selected to provide a short path for energetic carbon atoms ejected from the felt to easily backsputter onto the thruster discharge channel, enabling a visual verification of a successfully shielded thruster.

A scanning planar probe, comprised of a flat, circular, single-sided electrode with a negative voltage bias, was used to determine the ion current density and integrated beam current. The current density (Jᵢ) is calculated as Jᵢ=Iₚ/Aₚ where Iₚ is the ion current collected by the probe and Aₚ is the probe area. The total beam (ion) current is determined by integrating the current density azimuthally around the beam profile. Because a single probe scan measured the ion current from each side of the thruster, the ion current at each location is integrated around half of the azimuthal distance of the beam and then summed to account for any slight asymmetries in the beam profile. This simplifies to:

I_{b}=πwΣJ_{i,n}Rₙ Eq. 9

where w is the width of the beam sampled by the probe (equal to the resolution of the scan) and Rₙ is the nth lateral distance of the probe from the thruster's centerline (in the plane of the probe trace).
The planar probe used was an alumina-insulated 1.27 mm diameter tantalum wire with a 3.97 mm diameter, 0.13 mm thick molybdenum disk. The planar probe was scanned laterally +/−12 cm from the thruster's centerline and mounted 4.4 cm and 10.8 cm downstream of the thruster face. The 4.4 cm probe scan was used for ion current density measurements because charge exchange effects are minimized near the thruster while the 10.8 cm scan offered insight into the evolution of the plume's properties downstream of the thruster. The probe's electron-repelling bias was measured as −28 V relative to the chamber potential. A Velmex single-axis mechanical translation stage with supporting stepping motor controller provided horizontal motion across the thruster face at the set axial distance.

A retarding potential analyzer (RPA), utilizing a series of biased grids to measure ion energy, was also used in testing. The first grid is in contact with the plasma and floats relative to the plasma potential. The second grid is negatively biased to repel electrons, preventing them from entering the RPA and being collected by the ion collector electrode. The third (and sometimes fourth) grid is used as a positively biased ion discriminator, allowing only ions with energies greater than the applied voltage to reach the collector. The ion energy distribution is obtained by taking the first derivative of the current collected by the collector plate with respect to voltage.

The RPA built for this facility has a 9.53 mm diameter entrance orifice to the grid assembly. It uses stainless steel grids, each mounted to a 0.51 mm stainless steel ring; the individual plasma, electron repeller, and ion discriminator grid transparencies are 36%, 44%, and 40%, respectively. The RPA employs a four-grid design where the third and fourth grids, making up the ion discriminator, act as a double-discriminator (therefore, the effective grid transparency of the ion discriminator is 0.16). A four-grid design improves the energy resolution of the probe while preventing reductions in the discriminator potential at the centers of the ion grid orifices which may permit lower energy ions through the grid, leading to an over-estimate of collected ion current for a given discriminator potential. At the end of the assembly is a 0.77 mm thick stainless steel disk as a simple collector plate. Each grid is separated by a 0.38 mm insulator ring, and the entire assembly is insulated from the aluminum RPA body by a cylindrical insulator. The RPA's electron repelling grid was biased to −28 V relative to ground while the ion discriminator grid's swept potential was provided by an Acopain P10HP60 high voltage power supply. The RPA was mounted on (and grounded to) the frame of the high-energy beam dump, fixed 80 cm axially downstream of the MaSMi thruster's centerline.

Four Omega K-type thermocouples were mounted on the MaSMi thruster to monitor operational temperatures. Three thermocouples were held at the base of the discharge channel and approximately equally spaced in the azimuthal direction; the fourth was mounted on the outer pole piece, below and to the left of the cathode. Temperatures were measured with Fluke digital multimeters.

The initial performance characterization experiments for the MaSMi Hall thruster were conducted at a discharge voltage of 275 V and a discharge power of 325 W. Early operation point optimization began at 300 V and 1.3 A in an effort to achieve the original design point of 390 W; however, testing revealed that the final operation conditions (275 V and 325 W) yielded a more stable discharge and constant temperatures throughout the duration of a given test.

The anode propellant flow rate was set to 10.75 sccm of xenon while the cathode propellant flow rate was set to 1.1 sccm (10% of the anode flow rate). The inner and outer magnet coils were operated at 5.2 A and 1.5 A, respectively. Average operational temperatures of approximately 450° C. and 475° C. were measured at the base of the discharge channel and at the front pole piece, respectively. The thruster performance was measured during eight experimental trials with a total run-time of approximately 4 hours during this initial testing period.

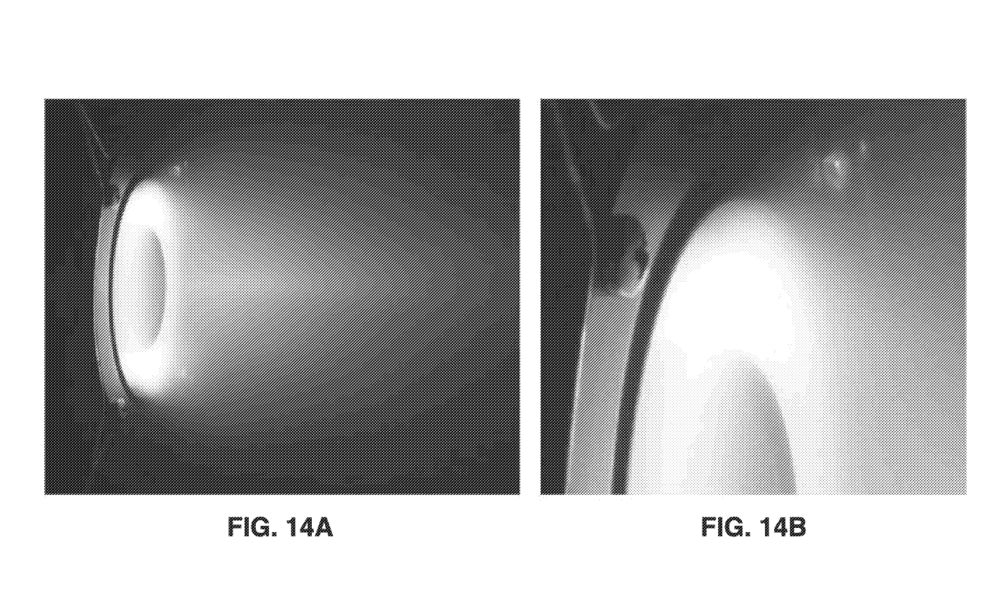

A photograph of the MaSMi Hall thruster during operation, with a magnified view of the upper discharge channel, is presented in FIG. 14A and FIG. 14B. To the naked eye, the plasma discharge appears to be slightly offset from the outer channel wall and more concentrated towards the center of the discharge channel. As seen in the close-up view of FIG. 14B, the offset indicates a significantly lower neutral excitation rate near the channel surfaces, suggesting that only low temperature plasma is interacting with the walls. Similar to the visual observations with the H6MS, this was the first evidence suggesting that the MaSMi thruster achieved a magnetically shielded field topology.

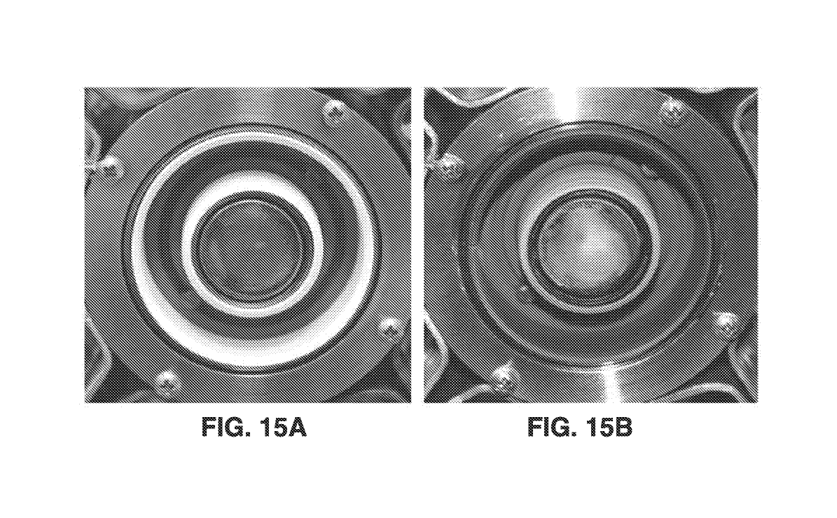

A visual inspection of the MaSMi thruster's inner and outer discharge channel walls was conducted after each performance test. As illustrated in FIG. 15A and FIG. 15B, an even coating of carbon had been deposited on the outer wall of the discharge channel along its full axial length and covering the chamfered exit region; no exposed BN was visible anywhere on the outer channel wall. The inner wall of the discharge channel was found to be noticeably darker (more gray) in color than it was before testing, suggesting some carbon deposition in this region. Thin exposed rings of clean BN were found along the edges of the chamfers on the inner wall near the downstream edge; however, the remaining surface area near the thruster exit had an obvious dusting of carbon, suggesting that weaker magnetic shielding was present.

The thick carbon coating of the outer wall suggests that the backsputter rate of carbon from the high-energy beam dump exceeded the ion sputter rate of the outer wall material. The inner wall also showed evidence that plasma-wall interactions had been reduced; however, localized magnetic circuit saturation was likely the cause of the weaker shielding of the inner wall. In an effort to bound the erosion rate of the thruster's discharge channel, a back-sputter calculation was performed to determine the rate of carbon redeposition on the discharge channel downstream-facing edges (the area of the most concentrated ion bombardment erosion).

The erosion rate of the BN discharge channel under xenon-ion bombardment (ε_{Xe-BN}) is bounded by:

$${ɛ}_{Xe \text{-} BN} \leq α {R}_{C} ( \frac{{ρ}_{C} {m}_{BN}}{{ρ}_{BN} {m}_{C}} ) ( \frac{{Y}_{Xe \text{-} BN}}{{Y}_{Xe \text{-} C / BN}} ) \approx 2 Rc ( \frac{{Y}_{Xe \text{-} BN}}{{Y}_{Xe \text{-} C / BN}} ) \qquad Eq . 10$$

where α is the sticking coefficient (assumed to be unity), R_{C} is the carbon backsputter rate, ρ_{C} is the mass density of carbon, m_{BN} is the particle mass of BN, ρ_{BN} is the mass density of BN, m_{C} is the particle mass of carbon, Y_{Xe-BN} is the sputter yield of BN under xenon ion incidence, and Y_{Xe-C/BN} is the sputter yield of carbon-coated BN under xenon ion incidence.

The sputter yield of carbon from the high energy beam dump was 7.2×10⁻² atoms/ion, calculated using the methods for carbon material sputtering presented by Tartz and assuming perpendicular ion incidence to the beam dump. The ion beam was assumed to strike the beam dump in a circular profile of radius 50 cm, calculated based on the beam divergence half-angle of 30° originating from the thruster channel's outer wall. An expected 4.7×10¹⁷ carbon atoms/s will be ejected from the beam dump, calculated by converting the measured ion current into number of ions incident on the dump per second and then multiplying by the sputter yield.

A view factor was calculated from each of the discharge channel downstream edges' projected areas (two concentric annuli with thicknesses equal to that of the discharge channel walls) to the projected beam area, resulting in a view factor of 5.5×10⁻⁵ and 9.7×10⁻⁵ for the inner and outer edges, respectively. Multiplying these view factors by the number of carbon atoms ejected from the beam dump gives the total number of carbon atoms expected to be deposited on the channel's downstream edges, yielding 2.6×10¹³ atoms/s and 4.6×10¹⁴ atoms/s for the inner and outer edges, respectively. Assuming an average distance between the sputter-deposited carbon atoms' nuclei of 140 pm, the number of atoms required to yield a 1 μm thick layer on the inner and outer edges' projected areas are 5.6×10¹⁹ atoms/μm and 9.7×10¹⁹ atoms/μm, respectively. The product of the inverse of these values and the number of carbon atoms deposited on the channel edges per second gives a total carbon deposition rate of approximately 1.7×10⁻³ μm/h for both the inner and outer discharge channel edges.

Applying this result to Eq. 10 gives a maximum channel erosion rate that is approximately 3×10⁻² μm/h where the sputter yield ratio is conservatively assumed to be 10. Although the simplifying assumptions for these erosion rates yield a very large uncertainty, the reported values are approximately three orders of magnitude below common erosion rates of unshielded Hall thrusters. Therefore, an error of several orders of magnitude in the calculated erosion rate (which is possible, however unlikely, due to the applied calculation method) still demonstrates a significant improvement over unshielded Hall thrusters.

In addition to the useful life of the device (discussed above), the key figures of merit for the MaSMi Hall thruster are thrust, specific impulse, and efficiency. The thrust (T) is given by:

$$T = {\sum }_{i} {\dot{m}}_{i} 〈 {v}_{i} 〉 = {η}_{b} {I}_{d} \sqrt{\frac{2 {MV}_{d} {η}_{v} {η}_{d}}{e}} {\sum }_{i} \frac{{f}_{i}}{{Z}_{i}} \qquad Eq . 11$$

where \dot{m}ᵢ is the ion mass flow rate, <vᵢ> is the average ion velocity, V_{d} is the discharge voltage, ηᵥ is the beam voltage utilization efficiency, η_{d} is the plume divergence efficiency, Zᵢ is the charge state of the ith ion species, and fᵢ is the current fraction of the ith species given by:

$${f}_{i} = \frac{{I}_{i}}{{I}_{b}} \qquad Eq . 12$$

where Iᵢ is the current of the ith ion species (the efficiencies in Eq. 11 are defined below).

The correction term in Eq. 11, which accounts for the presence of multiply charged species in the ion beam, can be calculated for any number of ion charge states as:

$${\sum }_{i} \frac{{f}_{i}}{{Z}_{i}} = \frac{{I}^{+} + \frac{1}{2} {I}^{++} + \frac{1}{3} {I}^{++ +} + …}{{I}_{b}} \qquad Eq . 13$$

where I⁺, I⁺⁺, and I⁺⁺⁺ are the currents of singly, doubly, and triply ionized particles in the plasma beam.

The specific impulse (Iₛₚ) is given by

$${I}_{sp} = \frac{T}{{\dot{m}}_{a} g} = \frac{{η}_{m}}{g} \sqrt{\frac{2 e {V}_{d} {η}_{v} {η}_{d}}{M}} ( \frac{{\sum }_{i} \frac{{f}_{i}}{\sqrt{{Z}_{i}}}}{{\sum }_{i} \frac{{f}_{i}}{{Z}_{i}}} ) \qquad Eq . 14$$

where \dot{m}ₐ is the thruster anode mass flow rate, g is the acceleration of gravity at the Earth's surface, ηₘ is the mass utilization efficiency (defined below), and:

$${\sum }_{i} \frac{{f}_{i}}{\sqrt{{Z}_{i}}} = \frac{{I}^{+} + \sqrt{\frac{1}{2}} {I}^{++} + \sqrt{\frac{1}{3}} {I}^{++ +} + …}{{I}_{b}} . \qquad Eq . 15$$

The total efficiency (η_{T}) is the ratio of the jet power (Pⱼₑₜ) in the thruster exhaust to the total thruster input power:

$${η}_{T} = \frac{{P}_{jet}}{{P}_{T}} = ( \frac{{T}^{2}}{2 {\dot{m}}_{a} {P}_{d}} ) ( \frac{{\dot{m}}_{a}}{{m}_{T}} ) ( \frac{{P}_{d}}{{P}_{T}} ) = {η}_{a} {η}_{c} {η}_{o} = {η}_{t c} {η}_{o} \qquad Eq . 16$$

where P_{T} is the total thruster input power (sum of the discharge, magnet, and keeper powers), \dot{m}_{T} is the total propellant flow rate (sum of the anode and cathode flow rates), ηₐ is the anode efficiency, η_{c} is the cathode efficiency, ηₒ is the electrical utilization efficiency, and η_{tc} is an effective thruster efficiency consisting of the efficiency contributions of the thruster and cathode only.

The anode efficiency can be broken into the product of five utilization efficiencies given by:

$${η}_{a} = \frac{{T}^{2}}{2 {\dot{m}}_{a} {P}_{d}} = {η}_{v} {η}_{b} {η}_{m } {η}_{d} {η}_{q} \qquad Eq . 17$$

where the utilization efficiencies for the beam voltage, beam current, mass, plum divergence, and charge (η_{q}) are:

$${η}_{v} = \frac{{V}_{b}}{{V}_{d}} , {η}_{b} = \frac{{I}_{b}}{{I}_{d}} , \\ {η}_{m} = \frac{{\dot{m}}_{b}}{{\dot{m}}_{a}} = \frac{{MI}_{d}}{{\dot{m}}_{a} e} {η}_{b} {\sum }_{i} \frac{{f}_{i}}{{Z}_{i}} , \\ {η}_{d} = {( cos θ )}^{2} , {η}_{q} = \frac{{( {\sum }_{i} \frac{{f}_{i}}{\sqrt{{Z}_{i}}} )}^{2}}{{\sum }_{i} \frac{{f}_{i}}{{Z}_{i}}} . \qquad Eq . 18$$

In these equations, \dot{m}_{b} is the beam propellant flow rate and θ is the plume divergence half-angle. The cathode, electrical utilization, and effective thruster efficiencies are given as:

$${η}_{c} = \frac{{\dot{m}}_{a}}{{\dot{m}}_{a} + {\dot{m}}_{c}} = \frac{{\dot{m}}_{a}}{{\dot{m}}_{T}} , \\ {η}_{o} = \frac{{P}_{d}}{{P}_{T}} = \frac{{V}_{d} {I}_{d}}{{V}_{d} {I}_{d} + {P}_{ma g} + {P}_{k}} , \\ {η}_{tc} = {η}_{a} {η}_{c} \qquad Eq . 19$$

where \dot{m}_{c} is the cathode mass flow rate, P_{mag} is the magnet power, and Pₖ is the keeper power.

Due to the relatively high background pressures observed during thruster operation, a method for compensating for neutral gas entrained into the thruster channel was implemented. The entrained mass flow (\dot{m}ₑₙ) is given by:

$${\dot{m}}_{en} = {A}_{en} \frac{{n}_{n} M}{4} {( \frac{8 {kT}_{n}}{π M} )}^{1 / 2} = {A}_{en} {P ( \frac{M}{2 π {kT}_{n}} )}^{1 / 2} \qquad Eq . 20$$

where Aₑₙ is the entrainment area approximated as a hemisphere with a radius equal to the discharge channel outer diameter, Tₙ is the temperature of the background neutral particles, and P is the facility pressure.

This entrained mass flow can then be converted to account for entrained discharge current (Iₑₙ) given by:

$${I}_{en} = {\dot{m}}_{en} \frac{e}{M} \qquad Eq . 21$$

where it is assumed that the neutral particles are singly ionized.

These corrections can be applied to the measured discharge current and anode flow rate as:

I_{d,true}=I_{d}−Iₑₙ, \dot{m}_{a,true}=\dot{m}ₐ+\dot{m}ₑₙ. Eq. 22

where the subscript true represents the corrected value. The entrained mass correction for thrust (Tₜᵣᵤₑ) is given by:

$${T}_{true} = T ( 1 - {ζ}_{en} \frac{{\dot{m}}_{en}}{{\dot{m}}_{a , true}} ) \qquad Eq . 23$$

where ζₑₙ is the entrained mass utilization factor used to account for ingested neutrals that were ionized but that did not contribute to useful thrust. The value of the entrained mass utilization factor is 0.5 according to the literature. The corrected specific impulse (I_{sp,true}) can then be calculated from Eq. 14 using the corrected thrust (Eq. 23) and the measured anode propellant flow rate because only the thrust term is dependent on the facility pressure. Using the corrected thrust and specific impulse, a corrected total efficiency (η_{T,true}) can be calculated using a modified form of Eq. 16 given as:

$${η}_{T , true} = [ \frac{g}{2} ( \frac{{I}_{sp , true} {T}_{true}}{{P}_{T , true}} ) ] {η}_{c , true} {η}_{o , true} \qquad Eq . 24$$

where P_{T,true}, η_{c,true}, and η_{o,true} are given by:

$${P}_{T , true} = {V}_{d} {I}_{d , true} + {P}_{mag} + {P}_{k} , \\ {η}_{c , true} = \frac{{\dot{m}}_{a , true}}{{\dot{m}}_{a , true} + {\dot{m}}_{c}} , \\ {η}_{o , true} = \frac{{V}_{d} {I}_{d , true}}{{P}_{T , true}} . \qquad Eq . 25$$

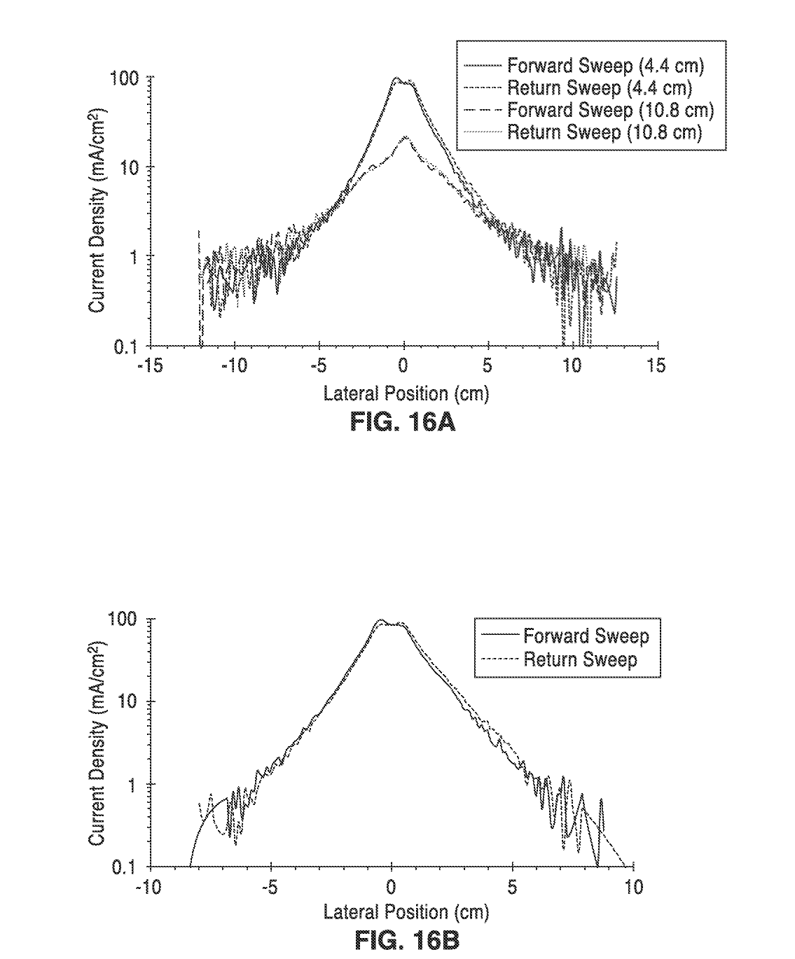

The current density was measured by the planar probe at both the 4.4 cm and 10.8 cm downstream locations as a function of the probe's lateral position from the thruster centerline is presented in FIG. 16A. Both the forward and return sweeps are shown for each axial distance to demonstrate repeatability of the measurement.

The ion current was determined from the 4.4 cm downstream planar probe trace because charge exchange effects are reduced, but not eliminated, near the thruster face (in this case, one discharge channel diameter downstream). A correction is therefore necessary to account for facility background charge exchange ion effects, which exist both in the wings of the probe trace as well as near the thruster centerline. This was accomplished by first determining the average value of the ion current density from +/−7 cm to +/−12 cm laterally away from the thruster centerline (encompassing the wings of the trace), which was approximately 0.68 mA/cm². This value was then subtracted from each ion current density measurement to account for effects of background charge exchange ions across the entire probe trace. The calculated ion current using this charge exchange correction was slightly more conservative than using an exponential curve generated for the data collected near the thruster axis and extended to the limits of the data collection range. The corrected ion current density as a function of the probe's lateral position for the thruster centerline is shown in FIG. 16B. Again, both the forward and return sweeps are presented to show measurement repeatability.

The ion current, calculated from Eq. 9 and based on the current density measurement corrected for background charge exchange ion effects, was 1.04 A. Several methods were employed to determine the approximate uncertainty of this measurement. Sheath expansion effects were considered, however, the results presented are applicable to a double-sided flat probe in a stationary plasma. Because the ions in a Hall thruster discharge comprise a flowing plasma (on the order of 10's of km/s) and the planar probe utilized was single-sided, it was assumed that sheath expansion effects were negligible. Additionally, the probe was observed to be cooler than the temperature required for significant electron current emission. The beam current utilization efficiency, calculated using Eq. 18, was therefore found to be 88% with an uncertainty of approximately +2%/−8% related to the planar probe measurement.

The plume divergence angle was approximated by determining the portion of the beam that contained 95% of the total current (corrected for charge exchange). A beam divergence half-angle of approximately 30° was observed, yielding a plume divergence efficiency of 75% (Eq. 18) with an uncertainty of approximately +2%/−8% based on the planar probe measurement.

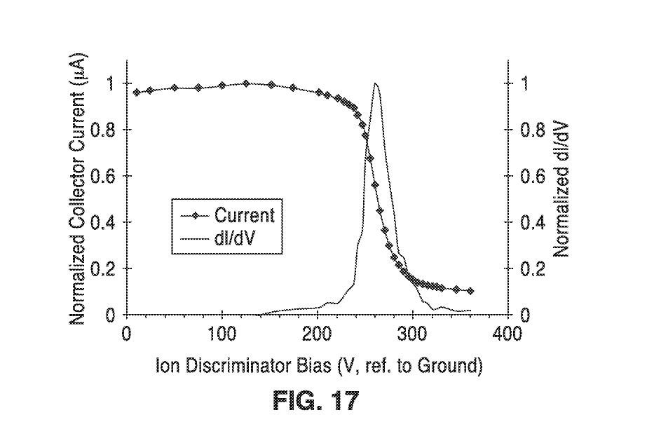

The ion current collected from the RPA traces are presented in FIG. 17; both the normalized ion current and its normalized derivative with respect to voltage are presented as functions of the ion discriminator grid bias for the nominal operation point of the MaSMi Hall thruster.

The most probable ion potential measured directly from the RPA was approximately 261 V; however, this value must be corrected to account for the plasma potential at the RPA location (the RPA body was grounded during this test). The floating potential was measured from the RPA's plasma grid during each thruster test and values were approximately 1 V. Because an emissive probe was unavailable to directly measure the plasma potential at the RPA location, a series of assumptions were made to determine this value. First, a local electron temperature of 3 eV was assumed at the RPA location; this relatively high value was selected to maintain a conservative estimate of the plasma potential. Second, the plasma potential was approximated by equating the electron current with the fast (beam) and slow (charge exchange) ion currents local to the RPA, taking the form of:

$$\frac{1}{4} {n}_{e} {eA}_{RPA} \sqrt{\frac{8 {kT}_{e}}{π m}} {e}^{- \frac{e Φ}{{kT}_{e}}} = {eA}_{RPA} ( \frac{1}{2} {n}_{i , slow} \sqrt{\frac{{kT}_{e}}{M}} + {n}_{i , fast} \sqrt{\frac{2 e {η}_{v} {V}_{d}}{M}} ) \qquad Eq . 26$$

where A_{RPA} is the area of the RPA orifice, n_{i,slow} is the slow ion density, and n_{i,fast} is the fast ion density. The fast ion density near the RPA was approximated based on the plasma density calculated from the planar probe measurements taken at 4.4 cm and 10.8 cm downstream of the thruster and then extrapolated for a 30° plume expansion based on the ratio of the beam area at the two downstream locations. The centerline values of the plasma density were used for this calculation as the RPA was located axially downstream of the thruster. This resulted in a plasma density reduction factor of approximately 1.6×10¹⁵ m⁻¹ divided by the beam area at a given downstream location, yielding a fast ion density of 2.4×10¹⁵ m⁻³ near the RPA. The slow ion density was calculated based on equating the rate of charge exchange ion production in the beam and the rate of ions lost from the beam traveling at the Bohm velocity. The resulting slow ion density was several orders of magnitude smaller than the fast ion density and was neglected, which allowed for the assumption of quasineutrality (nₑ≈n_{i,fast}). The voltage utilization efficiency was initially guessed and then iterated on simultaneously with the plasma potential, φ (note that Equation 26 is a function of both the plasma potential and the voltage utilization efficiency). The result was a calculated plasma potential of 8 V, or roughly 3Tₑ, above the local floating potential. Subtracting the calculated plasma potential and 1 V floating potential from the RPA-measured ion energy results in a most probable ion potential of 252 V; an approximate uncertainly of the plasma potential of 2Tₑ (6 V) was assumed. Applying these values to Eq. 18, a voltage utilization efficiency of 92% is achieved with an uncertainty of approximately +/−3%.

To calculate the MaSMi thruster total efficiency, the ion beam composition must be assumed (recall that ExB probe measurements were unavailable at the time of testing). Conventionally unshielded miniature Hall thrusters of the same scale as MaSMi generate favorable ion species mixes. The BHT-200-X3, for example, produces approximately 95.5% singly charged, 3.7% doubly charged, and 0.8% triply charged ions. By contrast, the H6MS Hall thruster generates a species mix of 57.5% singly, 25.9% doubly, and 16.6% triply and quadruple charged ions. In an effort to maintain conservative results, the MaSMi thruster beam was assumed to be composed of three ion charge states and that the species mix was equal to that produced by the H6MS.

Using the H6MS species mix, the mass utilization efficiency was calculated using Eq. 18. This resulted in a mass utilization efficiency of 102% with an assumed uncertainty of +0%/−10%. The mass utilization efficiency was calculated to be greater than 100% due to uncertainty in the ion current probe measurement and the ion species fractions. The cathode efficiency, calculated as a ratio of the corrected anode flow rate and total propellant flow rate, was approximately 91% with an uncertainty of less than +/−1% as reported by the flow controller manufacturer.

The MaSMi thruster's electrical utilization efficiency was calculated based on the power supply readings during stable operation. Nominal operation of the thruster occurred at 275 V with a discharge power of 325 W. The hollow cathode keeper, which was left on during all testing to avoid having to restart the cathode heater if the anode discharge went out, was current controlled at 2 A with a power of 40 W. The inner and outer magnet coils operated at 5.2 A and 1.5 A, respectively, for a combined power of 29 W. Summing these values, the MaSMi thruster total power was 394 W with an electrical efficiency of 83%. This value has an uncertainty of less than +/−1% as reported by the power supply manufacturers.

A summary of MaSMi thruster's total efficiency, including each contributing term from Eq. 17, is presented in Table 1. The MaSMi Hall thruster demonstrated a calculated total efficiency of approximately 44% with an uncertainty of +5%/−15% (uncorrected for the effects of background neutrals). This corresponds to a thrust of approximately 20 mN at a specific impulse of approximately 1940 s. The MaSMi thruster anode efficiency was approximately 59% with an uncertainty of +6%/−19% while the thruster efficiency (thruster and cathode contributions) was approximately 54% with an uncertainly of +6%/−18%. A summary of the three measures of the MaSMi thruster calculated efficiency is presented in Table 2. It should be noted that while the calculated thrust matches very well with the pre-fabrication scaling model's prediction, a significant difference was observed in the predicted and measured specific impulse likely due to the high multiply charged ion content of the beam not considered in the scaling model.

The values discussed above represent the performance of the thruster without considering the presence of entrained background neutrals and must therefore be corrected. An entrained mass flow of approximately 8.2×10⁻⁸ kg/s was calculated using Eq. 20, yielding an entrained current of approximately 60 mA (Eq. 21), or 5% of the discharge current. The thrust correction (Eq. 23) applied to the calculated thrust yields a true thrust of approximately 19 mN, corresponding to a specific impulse of approximately 1870 s. Applying these values to Eq. 24 gives a true (or vacuum) total efficiency of 43%. If the total efficiency is calculated using a common beam composition for miniature Hall thrusters (the BHT-200, for example) instead of the more conservative H6MS species mix, the true total efficiency increases significantly.

The total efficiency changed by approximately 1% with the application of the background neutral correction due to the calculated entrained mass flow, which is two orders of magnitude smaller than the measured anode mass flow. Additionally, assuming a +/−20% uncertainty in the facility pressure (used to calculate the entrained mass flow) resulted in a change of significantly less than +/−1% uncertainty in the thruster's true total efficiency.

From the description herein, it will be appreciated that that the present disclosure encompasses multiple embodiments which include, but are not limited to, the following:

1. A miniature Hall thruster, comprising: a discharge component; the discharge component comprising channel walls defining a discharge channel; an anode disposed in a first end of said discharge channel; the discharge channel having an open second end opposite said first end; the discharge channel configured to create a magnetic shield disposed to at least partially encircle said channel walls of said discharge component; and wherein said magnetic shield is configured to manipulate a magnetic field associated with the discharge component such that the magnetic field extends into said discharge channel from said open second end substantially without intercepting said channel walls of said discharge component so as to prevent a plasma formed in said discharge channel from contacting said channel walls.

2. The miniature Hall thruster of any preceding embodiment, wherein an output power of said Hall thruster is less than 1 kW.

3. The miniature Hall thruster of any preceding embodiment, wherein the power of said Hall thruster is less than 1 kW and greater than 25 W.

4. The miniature Hall thruster of any preceding embodiment, wherein a power of said Hall thruster is less than 500 kW and greater than 100 W.

5. The miniature Hall thruster of any preceding embodiment, wherein said discharge channel has a diameter that is less than 10 cm.

6. The miniature Hall thruster of any preceding embodiment, wherein said discharge channel has a diameter that is less than 6 cm.

7. The miniature Hall thruster of any preceding embodiment, wherein said discharge channel has a width that is greater than 1 mm.

8. The miniature Hall thruster of any preceding embodiment, wherein said magnetic shield is configured to prevent said plasma formed in said discharge channel from contacting said channel walls by an amount such that said Hall thruster has an operational lifetime greatly in excess of 1000 hours and a total efficiency of greater than 30%.

9. The miniature Hall thruster of any preceding embodiment, further comprising: inner and outer magnetic screens disposed between inner and outer pole pieces and the discharge channel;

wherein the geometry of the inner and outer screens is configured to manipulate the shape of the magnetic field.

10. The miniature Hall thruster of any preceding embodiment: wherein the discharge channel comprises an annular channel disposed around a magnetic core; wherein the inner and outer magnetic screens comprise thin, hollow, open-ended cylinders disposed between the magnetic core and the discharge channel; wherein the magnetic field comprises magnetic field lines passing through the inner and outer pole pieces; and wherein the geometry of the inner and outer screens is configured to generate “U” shaped magnetic field lines across and into the discharge channel from the open second end.

11. The miniature Hall thruster of any preceding embodiment: wherein the magnetic field is generated by inner and outer magnetic coils disposed substantially adjacent to the inner and outer screens; and wherein the inner and outer screens are configured to shunt the magnetic field lines into the “U” shaped configuration without crossing the discharge channel walls.

12. The miniature Hall thruster of any preceding embodiment, wherein the discharge channel has one or more chamfers to achieve a field topography that prevents the magnetic field lines from intersecting the discharge channel walls.

13. The miniature Hall thruster of any preceding embodiment, wherein the inner and outer magnetic screens are axially spaced adjacent to, or nearly adjacent to, the inner and outer pole pieces.

14. A miniature Hall thruster, comprising: a discharge component; the discharge component comprising channel walls defining a discharge channel; an anode disposed in a first end of said discharge channel; the discharge channel having an open second end opposite said first end; inner and outer pole pieces adjacent said second open end; inner and outer magnetic screens disposed between the inner and outer pole pieces and the discharge channel; wherein the Hall thruster configured to create a magnetic shield disposed to at least partially encircle said channel walls of said discharge component; and wherein the geometry of the inner and outer screens is configured to manipulate the shape of the magnetic shield such that the magnetic field extends into said discharge channel from said open second end substantially without intercepting said channel walls of said discharge component so as to prevent a plasma formed in said discharge channel from contacting said channel walls.

15. The miniature Hall thruster of any preceding embodiment, wherein an output power of said Hall thruster is less than 1 kW.

16. The miniature Hall thruster of any preceding embodiment, wherein the power of said Hall thruster is less than 1 kW and greater than 25 W.

17. The miniature Hall thruster of any preceding embodiment, wherein a power of said Hall thruster is less than 500 kW and greater than 100 W.

18. The miniature Hall thruster of any preceding embodiment, wherein said discharge channel has a diameter that is less than 10 cm.

19. The miniature Hall thruster of any preceding embodiment, wherein said discharge channel has a diameter that is less than 6 cm.

20. The miniature Hall thruster of any preceding embodiment, wherein said discharge channel has a width that is greater than 1 mm.

21. The miniature Hall thruster of any preceding embodiment, wherein said magnetic shield is configured to prevent said plasma formed in said discharge channel from contacting said channel walls by an amount such that said Hall thruster has an operational lifetime greatly in excess of 1000 hours and a total efficiency of greater than 30%.

22. The miniature Hall thruster of any preceding embodiment: wherein the discharge channel comprises an annular channel disposed around a magnetic core; wherein the inner and outer magnetic screens comprise thin, hollow, open-ended cylinders disposed between the magnetic core and the discharge channel; wherein the magnetic field comprises magnetic field lines passing through the inner and outer pole pieces; and wherein the geometry of the inner and outer screens is configured to generate “U” shaped magnetic field lines across and into the discharge channel from the open second end.

23. The miniature Hall thruster of any preceding embodiment: wherein the magnetic field is generated by inner and outer magnetic coils disposed substantially adjacent to the inner and outer screens; and wherein the inner and outer screens are configured to shunt the magnetic field lines into the “U” shaped configuration without crossing the discharge channel walls.

24. The miniature Hall thruster of any preceding embodiment, wherein the discharge channel has one or more chamfers to achieve a field topography that prevents the magnetic field lines from intersecting the discharge channel walls.

25. The miniature Hall thruster of any preceding embodiment, wherein the inner and outer magnetic screens are axially spaced adjacent to, or nearly adjacent to, the inner and outer pole pieces.

26. A method for generating thrust from a miniature Hall thruster, the hall thruster comprising a discharge channel defined by channel walls disposed between a first end having an anode and a second open end, the method comprising: creating a magnetic shield disposed to at least partially encircle the channel walls of the discharge channel; manipulating a magnetic field associated with the discharge component such that the magnetic field extends into said discharge channel from said open second end substantially without intercepting said channel walls of said discharge component so as to prevent a plasma formed in said discharge channel from contacting said channel walls; and generating a thrust from the Hall thruster; said thrust having an output power less than 1 kW.

27. The method of any preceding embodiment, wherein the output power is less than 1 kW and greater than 25 W.

28. The method of any preceding embodiment, wherein the output power is less than 500 kW and greater than 100 W.

29. The method of any preceding embodiment: (a) the Hall thruster further comprising: an annular discharge channel disposed around a magnetic core, the inner and outer magnetic screens disposed between magnetic core and the discharge channel, and inner and outer pole pieces adjacent said second open end; (b) the method further comprising: manipulating magnetic field lines in a “U” shape to pass through the inner and outer pole pieces, across the second open end of the discharge channel and into the discharge channel; wherein the geometry of the inner and outer screens is configured to generate magnetic field lines across and into the discharge channel from the open second end.

30. The method of any preceding embodiment, wherein the magnetic field lines are manipulated as a function of the geometry of the inner and outer screens.

31. The method of any preceding embodiment: wherein the magnetic field lines are generated by inner and outer magnetic coils disposed substantially adjacent to the inner and outer screens; and wherein manipulating the magnetic field lines comprises shunting the magnetic field lines into the “U” shaped configuration without crossing the discharge channel walls.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Summary of the MaSMi Thruster Efficiency

| | Efficiency | Uncertainty |
|---|---|---|
| η_{b} | 88% | +2%/−8% |
| ηᵥ | 92% | +/−3% |
| ηₘ | 102% | +0%/−10% |
| η_{d} | 75% | +2%/−8% |
| η_{q} | 96% | +2%/−8% |
| η_{c} | 91% | +/−1% |
| ηₒ | 83% | +/−1% |
| η_{T} | 43% | +5%/−15% |

TABLE 2
Summary of the MaSMi anode, Thruster and Total Efficiency

| | Efficiency | Uncertainty |
|---|---|---|
| ηₐ | 59% | +6%/−19% |
| η_{tc} | 54% | +6%/−18% |
| η_{T} | 43% | +5%/−15% |

What is claimed is:

1. A miniature Hall thruster, comprising:
a discharge component;
the discharge component comprising channel walls defining a discharge channel;
an anode disposed in a first end of said discharge channel;
the discharge channel having an open second end opposite said first end;
the discharge channel configured to create a magnetic shield disposed to at least partially encircle said channel walls of said discharge component; and
wherein said magnetic shield is configured to manipulate a magnetic field associated with the discharge component such that the magnetic field extends into said discharge channel from said open second end substantially without intercepting said channel walls of said discharge component so as to prevent a plasma formed in said discharge channel from contacting said channel walls.

2. A miniature Hall thruster as recited in claim 1, wherein an output power of said Hall thruster is less than 1 kW.

3. A miniature Hall thruster as recited in claim 2, wherein the power of said Hall thruster is less than 1 kW and greater than 25 W.

4. A miniature Hall thruster as recited in claim 3, wherein a power of said Hall thruster is less than 500 kW and greater than 100 W.

5. A miniature Hall thruster as recited in claim 1, wherein said discharge channel has a diameter that is less than 10 cm.

6. A miniature Hall thruster as recited in claim 5, wherein said discharge channel has a diameter that is less than 6 cm.

7. A miniature Hall thruster as recited in claim 1, wherein said discharge channel has a width that is greater than 1 mm.

8. A miniature Hall thruster as recited in claim 1, wherein said magnetic shield is configured to prevent said plasma formed in said discharge channel from contacting said channel walls by an amount such that said Hall thruster has an operational lifetime greatly in excess of 1000 hours and a total efficiency of greater than 30%.

9. A miniature Hall thruster as recited in claim 1, further comprising:
inner and outer magnetic screens disposed between inner and outer pole pieces and the discharge channel;
wherein the geometry of the inner and outer screens is configured to manipulate the shape of the magnetic field.

10. A miniature Hall thruster as recited in claim 9:
wherein the discharge channel comprises an annular channel disposed around a magnetic core;
wherein the inner and outer magnetic screens comprise thin, hollow, open-ended cylinders disposed between the magnetic core and the discharge channel;
wherein the magnetic field comprises magnetic field lines passing through the inner and outer pole pieces; and
wherein the geometry of the inner and outer screens is configured to generate “U” shaped magnetic field lines across and into the discharge channel from the open second end.

11. A miniature Hall thruster as recited in claim 10:
wherein the magnetic field is generated by inner and outer magnetic coils disposed substantially adjacent to the inner and outer screens; and
wherein the inner and outer screens are configured to shunt the magnetic field lines into the “U” shaped configuration without crossing the discharge channel walls.

12. A miniature Hall thruster as recited in claim 10, wherein the discharge channel has one or more chamfers to achieve a field topography that prevents the magnetic field lines from intersecting the discharge channel walls.

13. A miniature Hall thruster as recited in claim 9, wherein the inner and outer magnetic screens are axially spaced adjacent to, or nearly adjacent to, the inner and outer pole pieces.

14. A miniature Hall thruster, comprising:
a discharge component;
the discharge component comprising channel walls defining a discharge channel;
an anode disposed in a first end of said discharge channel;
the discharge channel having an open second end opposite said first end;
inner and outer pole pieces adjacent said second open end;
inner and outer magnetic screens disposed between the inner and outer pole pieces and the discharge channel;
wherein the Hall thruster configured to create a magnetic shield disposed to at least partially encircle said channel walls of said discharge component; and
wherein the geometry of the inner and outer screens is configured to manipulate the shape of the magnetic shield such that the magnetic field extends into said discharge channel from said open second end substantially without intercepting said channel walls of said discharge component so as to prevent a plasma formed in said discharge channel from contacting said channel walls.

15. A miniature Hall thruster as recited in claim 14, wherein an output power of said Hall thruster is less than 1 kW.

16. A miniature Hall thruster as recited in claim 15, wherein the power of said Hall thruster is less than 1 kW and greater than 25 W.

17. A miniature Hall thruster as recited in claim 16, wherein a power of said Hall thruster is less than 500 kW and greater than 100 W.

18. A miniature Hall thruster as recited in claim 14, wherein said discharge channel has a diameter that is less than 10 cm.

19. A miniature Hall thruster as recited in claim 18, wherein said discharge channel has a diameter that is less than 6 cm.

20. A miniature Hall thruster as recited in claim 14, wherein said discharge channel has a width that is greater than 1 mm.

21. A miniature Hall thruster as recited in claim 14, wherein said magnetic shield is configured to prevent said plasma formed in said discharge channel from contacting said channel walls by an amount such that said Hall thruster has an operational lifetime greatly in excess of 1000 hours and a total efficiency of greater than 30%.

22. A miniature Hall thruster as recited in claim 14:
wherein the discharge channel comprises an annular channel disposed around a magnetic core;
wherein the inner and outer magnetic screens comprise thin, hollow, open-ended cylinders disposed between the magnetic core and the discharge channel;
wherein the magnetic field comprises magnetic field lines passing through the inner and outer pole pieces; and
wherein the geometry of the inner and outer screens is configured to generate “U” shaped magnetic field lines across and into the discharge channel from the open second end.

23. A miniature Hall thruster as recited in claim 22:
wherein the magnetic field is generated by inner and outer magnetic coils disposed substantially adjacent to the inner and outer screens; and
wherein the inner and outer screens are configured to shunt the magnetic field lines into the “U” shaped configuration without crossing the discharge channel walls.

24. A miniature Hall thruster as recited in claim 22, wherein the discharge channel has one or more chamfers to achieve a field topography that prevents the magnetic field lines from intersecting the discharge channel walls.

25. A miniature Hall thruster as recited in claim 14, wherein the inner and outer magnetic screens are axially spaced adjacent to, or nearly adjacent to, the inner and outer pole pieces.

26. A method for generating thrust from a miniature Hall thruster, the hall thruster comprising a discharge channel defined by channel walls disposed between a first end having an anode and a second open end, the method comprising:
creating a magnetic shield disposed to at least partially encircle the channel walls of the discharge channel;
manipulating a magnetic field associated with the discharge component such that the magnetic field extends into said discharge channel from said open second end substantially without intercepting said channel walls of said discharge component so as to prevent a plasma formed in said discharge channel from contacting said channel walls; and
generating a thrust from the Hall thruster;
said thrust having an output power less than 1 kW.

27. A method as recited in claim 26, wherein the output power is less than 1 kW and greater than 25 W.

28. A method as recited in claim 26, wherein the output power is less than 500 kW and greater than 100 W.

29. A method as recited in claim 26:
(a) the Hall thruster further comprising: an annular discharge channel disposed around a magnetic core, the inner and outer magnetic screens disposed between magnetic core and the discharge channel, and inner and outer pole pieces adjacent said second open end;
(b) the method further comprising:
manipulating magnetic field lines in a “U” shape to pass through the inner and outer pole pieces, across the second open end of the discharge channel and into the discharge channel;
wherein the geometry of the inner and outer screens is configured to generate magnetic field lines across and into the discharge channel from the open second end.

30. A method as recited in claim 29, wherein the magnetic field lines are manipulated as a function of the geometry of the inner and outer screens.

31. A method as recited in claim 29:
wherein the magnetic field lines are generated by inner and outer magnetic coils disposed substantially adjacent to the inner and outer screens; and
wherein manipulating the magnetic field lines comprises shunting the magnetic field lines into the “U” shaped configuration without crossing the discharge channel walls.
